(19) United States
(12) Patent Application Publication
(10) Pub. No.: US 2026/0253986 A1
(43) Pub. Date: Aug. 27, 2026

(54) BATTERY MODULE, BATTERY PACK INCLUDING THE SAME AND VEHICLE

(71) Applicant: LG ENERGY SOLUTION, LTD., Seoul (KR)

(72) Inventors: Byung Do JANG, Daejeon (KR); Hyoung Suk LEE, Daejeon (KR)

(73) Assignee: LG ENERGY SOLUTION, LTD., Seoul (KR)

(21) Appl. No.: 18/726,729

(22) PCT Filed: Mar. 23, 2023
(86) PCT No.: PCT/KR2023/003885

§ 371 Date: Jul. 3, 2024

(30) Foreign Application Priority Data
Mar. 23, 2022 (KR) 10-2022-0036333
Mar. 22, 2023 (KR) 10-2023-0037478

(51) Int. Cl. H01M 10/617; H01M 10/613; H01M 10/625; H01M 10/6556; H01M 10/6568

(52) U.S. Cl. CPC H01M 10/617; H01M 10/613; H01M 10/625; H01M 10/6556; H01M 10/6568

(57) ABSTRACT

A battery module includes a case assembly configured to accommodate and cool a battery cell, wherein the case assembly includes: a top cooling member; a bottom cooling member; and a connector member. Thus, the entire battery cell may be uniformly cooled, and a temperature deviation of the entire battery cell may be minimized.

### CROSS-REFERENCE TO RELATED APPLICATION

The present application claims the benefit of the priority of Korean Patent Application Nos. 10-2022-0036333, filed on Mar. 23, 2022, and 10-2023-0037478, filed on Mar. 22, 2023, which are hereby incorporated by reference in their entirety.

### TECHNICAL FIELD

The present invention relates to a battery module capable of minimizing a temperature deviation in an entire battery cell during cooling of the battery cell and improving cooling efficiency, a battery pack including the same, and vehicle.

### BACKGROUND ART

In general, secondary batteries are commonly applied to portable devices as well as electric vehicles (EVs) or hybrid electric vehicles (HEVs) driven by an electric driving source. These secondary batteries are attracting attention as a new energy source for improving eco-friendliness and energy efficiency in that the secondary batteries are capable of drastically reducing the use of fossil fuels and do not generate any by-products.

The plurality of secondary batteries are connected to each other to constitute a battery module. Here, the battery module needs a cooling system to prevent overheating. That is, as a capacity of the battery module increases, an amount of generated heat increases, and thus, a water-cooling type cooling system is required instead of an air-cooling type cooling system.

However, the water-cooling type cooling system according to the related art has a problem in that it is difficult to uniformly cool the entire battery module. That is, the water-cooling type cooling system according to the related art has a problem in that a temperature deviation in entire battery module occurs, and as a result, cooling efficiency is deteriorated.

### DISCLOSURE OF THE INVENTION

### Technical Problem

An object of the present invention is to provide a battery module capable of minimizing a temperature deviation in an entire battery cell during cooling of the battery cell and improving cooling efficiency, a battery pack including the same, and vehicle.

### Technical Solution

A battery module of the present invention includes a case assembly configured to accommodate and cool a battery cell, wherein the case assembly includes: a top cooling member provided with a top plate configured to cover a top surface of the battery cell, a first heatsink configured to cool the top surface of the battery cell while cooling water passes therethrough, a first supply port configured to supply the cooling water to the first heatsink, and a first discharge port configured to discharge the cooling water passing through the first heatsink; a bottom cooling member provided with a bottom plate configured to cover a bottom surface of the battery cell, a second heatsink configured to cool the bottom surface of the battery cell while the cooling water passes therethrough, a second supply port configured to supply the cooling water to the second heatsink, and a second discharge port configured to discharge the cooling water passing through the second heatsink; and a connector member provided with a front plate configured to cover a front surface of the battery cell, a supply part configured to supply the cooling water to the first supply port and the second supply port, and a collection part configured to collect the cooling water discharged from the first discharge port and the second discharge ports, wherein the front plate includes: a pair of side covers configured to cover sides of the front surface, respectively; and a central cover which is provided between the pair of side covers, wherein the central cover protrudes outward from each of the pair of side covers.

The supply part and the collection part may be provided in the front plate.

The supply part may include: a first connection passage provided in the central cover to pass vertically and having an upper end and a lower end, to which the first supply port and the second supply port are coupled respectively, to supply the cooling water to the first and second supply ports; and a supply passage configured to pass from an outside of the central cover to the first connection passage and supply the cooling water to the first connection passage.

The supply passage may be configured to pass from a first side portion of the central cover, which protrudes from a first side cover of the pair of side covers, to the first connection passage.

The collection part comprises: a second connection passage provided in the central cover to vertically pass and having an upper end and a lower end, to which the first discharge port and the second discharge port are coupled, respectively, so that the cooling water discharged from the first and second discharge ports passes therethrough; and a collection passage configured to pass from outside of the central cover to the second connection passage and collect the cooling water passing through the second connection passage.

The collection passage may be configured to pass from a second side portion of the central cover, which protrudes from a second side portion of the pair of side covers, to the second connection passage.

A coupling hole into which each of the first and second supply ports is fitted may be defined in each of the ends of the first connection passage, and a coupling piece on each of the first supply port and the second supply port may be coupled to the first connection passage may be disposed on each of the first supply port and the second supply port.

A coupling hole into which each of the first and second discharge ports is fitted may be defined in each of both ends of the second connection passage, and a coupling piece on each of the first discharge port and the second discharge port may be coupled to the second connection passage.

A sealing ring may be provided between the coupling hole of the first connection passage and the first supply port or between the coupling hole of the first connection passage and the second supply port.

A sealing ring may be provided between the coupling hole of the second connection passage and the first discharge port or between the coupling hole of the second connection passage and the second discharge port.

The battery module may further include a pair of side plates configured to cover side surfaces of the battery cell, respectively.

The pair of side plate and the bottom plate may be integrated with each other.

The battery module may further include a rear plate configured to cover a rear surface of the battery cell.

A battery pack of the present invention includes: a pack case in which at least one battery module is accommodated, wherein the pack case includes: a supply line configured to supply cooling water to a supply passage of the at least one battery module; and a collection line through which the cooling water collected from the collection passage of the at least one battery module passes.

A vehicle of the present invention includes: a battery pack; and a cooling water supply device configured to supply cooling water to the supply line of the battery pack or collect the cooling water passing through the collection line.

### Advantageous Effects

The battery module of the present invention may include the case assembly for cooling the battery cell using the cooling water, and the case assembly may include the top cooling member, the bottom cooling member, and the connector member. Due to this feature, the upper and lower portions of the battery cell may be effectively cooled, and in particular, the entire battery cell may be uniformly cooled, and as a result, the cooling efficiency may be improved by minimizing the temperature deviation of the entire battery cell.

### BRIEF DESCRIPTION OF THE DRAWINGS

FIG. 1 is an exploded perspective view of a battery module according to a first embodiment of the present invention.

FIG. 2 is a front view of the pouch module according to the first embodiment of the present invention.

FIG. 3 is a plan view of the pouch module according to the first embodiment of the present invention.

FIG. 4 is a bottom view of the battery module according to the first embodiment of the present invention.

FIG. 5 is a cross-sectional view of first and second heatsinks according to the first embodiment of the present invention.

FIG. 6 is a cross-sectional view of a connector member according to the first embodiment of the present invention.

FIG. 7 is a partial enlarged view of FIG. 6.

FIGS. 8 to 11 are views illustrating a method for assembling a battery module according to the first embodiment of the present invention.

FIG. 12 is a schematic front view of a battery pack according to a second embodiment of the present invention.

FIG. 13 is a side view f a vehicle according to a third embodiment of the present invention.

### MODE FOR CARRYING OUT THE INVENTION

Hereinafter, embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein. In the drawings, anything unnecessary for describing the present invention will be omitted for clarity, and also like reference numerals in the drawings denote like elements.

### Battery Module According to First Embodiment of the Present Invention

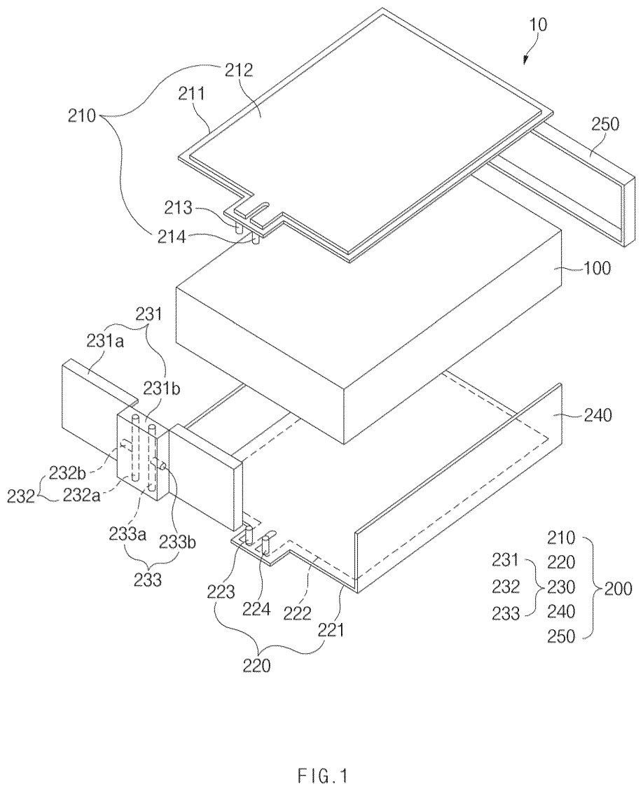

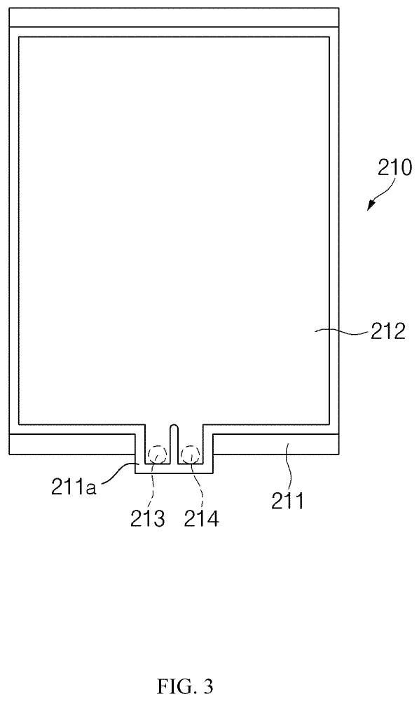

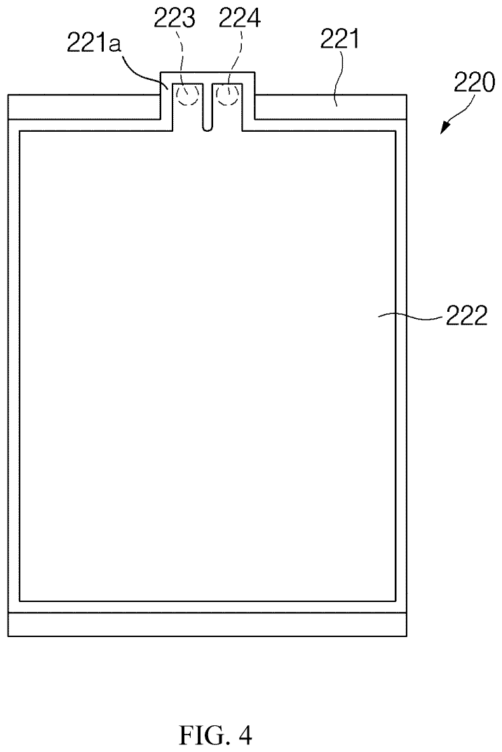

As illustrated in FIGS. 1 to 4, a battery module 10 according to a first embodiment of the present invention includes a battery cell 100 and a case assembly that cools the battery cell 100 using cooling water.

### Battery Cell

The battery cell 100 includes an electrode assembly, an electrolyte, and a case accommodating the electrode assembly and the electrolyte. The electrode assembly has a structure in which a plurality of electrodes and a plurality of separators are alternately disposed. The plurality of electrodes may be a positive electrode and a negative electrode.

### Case Assembly

The case assembly 200 includes a top cooling member 210 that cools an upper portion of the battery cell 100 using cooling water, a bottom cooling member 220 that cools a lower portion of the battery cell 100 using the cooling water, and a connector member 230 that supplies or collects the cooling water to/from the top cooling member 210 and the bottom cooling member 220. Here, the top cooling member 210 and the bottom cooling member 220 have a symmetrical structure with respect to the battery cell 100, and thus manufacturing efficiency may be improved.

The top cooling member 210 includes a top plate 211, a first heatsink 212, a first supply port 213 and a first discharge port 214.

The top plate 211 is made of a metal material and has an area covering an entire top surface of the battery cell 100. In addition, the top plate 211 is provided with an upper extension part 211a extending out of the battery cell 100, and the first supply port 213 and the first discharge port 214 are coupled to the upper extension part 211a. That is, the upper extension part 211a may separate the first supply port 213 and the first discharge port 214 from the battery cell 100 to prevent the first supply port 213 and the first discharge port 214 from being in contact with each other, and as a result, prevent the battery cell 100 from being damaged.

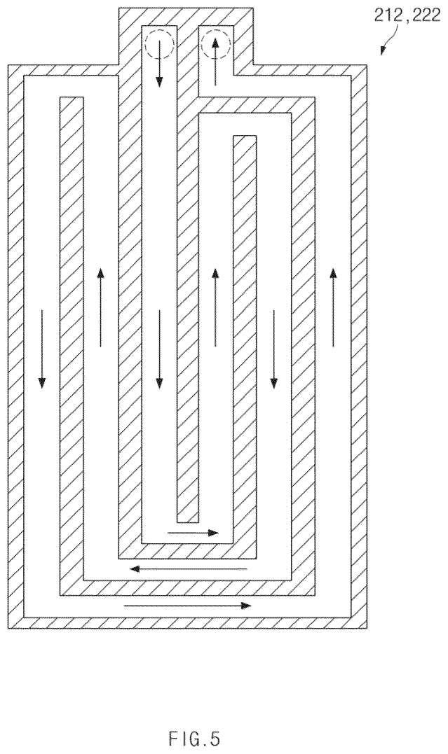

The first heatsink 212 is disposed on a top surface of the top plate 211 to cool the top surface of the battery cell 100 while the cooling water passes therethrough. That is, referring to FIG. 5, the first heatsink 212 cools the entire top surface of the battery cell 100 while providing a cooling water passages through which the cooling water passes in the entire surface. An inlet of the cooling water passage is connected to the first supply port 213, and an outlet is connected to the first discharge port 214.

The first supply port 213 is configured to supply the cooling water to the first heatsink 212 and also is coupled to one side of a bottom surface of the upper extension part 211a and is connected to the inlet of the cooling water passage provided in the first heatsink 212 to supply the cooling water to the cooling water passage of the first heatsink 212.

The first discharge port 214 is configured to discharge the cooling water passing through the first heatsink 212 and also is coupled to the other side of the bottom surface of the upper extension part 211a and is connected to the outlet of the cooling water passage provided in the first heatsink 212 to discharge the cooling water passing through the first heatsink 212.

When the top cooling member 210 having the above-described configuration is disposed on the top surface of the battery cell 100, the cooling water may be supplied into the first heatsink 212 through the first supply port 213, and the cooling water supplied into the first heatsink 212 may cool the entire top surface of the battery cell 100 while passing through the cooling water passage. Here, since the cooling water passage passes through the entire top surface of the battery cell 100, the entire top surface of the battery cell 100 may be uniformly cooled, and as a result, a temperature deviation of the entire top surface of the battery cell 100 may be minimized. The cooling water that has passed through the first heatsink 212 is discharged to the first discharge port 214.

The first supply port 213 and the first discharge port 214 may be detachably coupled to the upper extension part 211a. Thus, when the first supply port 213 and the first discharge port 214 are damaged, the first supply port 213 and the first discharge port 214 may be easily replaced.

The bottom cooling member 220 includes a bottom plate 221, a second heatsink 222, a second supply port 223 and a second discharge port 224.

The bottom plate 221 is made of a metal material and has an area covering the entire bottom surface of the battery cell 100. The bottom plate 221 is provided with a lower extension part 221a extending out of the battery cell 100, and the second supply port 223 and the second discharge port 224 are coupled to the lower extension part 221a. That is, the lower extension part 221a may separate the second supply port 223 and the second discharge port 224 from the battery cell 100 to prevent the second supply port 223 and the second discharge port 224 from being in contact with each other, and as a result, prevent the battery cell 100 from being damaged.

The second heatsink 222 is disposed on a bottom surface of the top plate 211 to cool the bottom surface of the battery cell 100 while the cooling water passes therethrough. Here, the second heatsink 222 has the same cooling water passage as the first heatsink 212. That is, referring to FIG. 5, the second heatsink 222 cools the entire bottom surface of the battery cell 100 while providing the cooling water passages through which the cooling water passes in the entire surface. The inlet of the cooling water passage is connected to the second supply port 223, and the outlet is connected to the second discharge port 224.

The second supply port 223 is configured to supply the cooling water to the second heatsink 222 and also is coupled to the top surface of the lower extension part 221a and is connected to the inlet of the cooling water passage provided in the second heatsink 222 to supply the cooling water to the cooling water passage of the second heatsink 222.

The second discharge port 224 is configured to discharge the cooling water passing through the second heatsink 222 and also is coupled to the top surface of the lower extension part 221a and is connected to the outlet of the cooling water passage provided in the second heatsink 222 to discharge the cooling water passing through the second heatsink 222.

When the bottom cooling member 220 having the above-described configuration is disposed on the bottom surface of the battery cell 100, the cooling water may be supplied into the second heatsink 222 through the second supply port 223, and the cooling water supplied into the second heatsink 222 may cool the entire bottom surface of the battery cell 100 while passing through the cooling water passage. Here, since the cooling water passage passes through the entire bottom surface of the battery cell 100, the entire bottom surface of the battery cell 100 may be uniformly cooled. The cooling water that has passed through the second heatsink 222 is discharged through the second discharge port 224.

In particular, the present invention has a structure in which the top cooling member 210 and the bottom cooling member 220 are symmetrical to each other, and thus, the top and bottom surfaces of the battery cell 100 may be uniformly cooled, particularly a temperature deviation of the top and bottom surfaces of the battery cell 100 may be minimized to improve cooling efficiency.

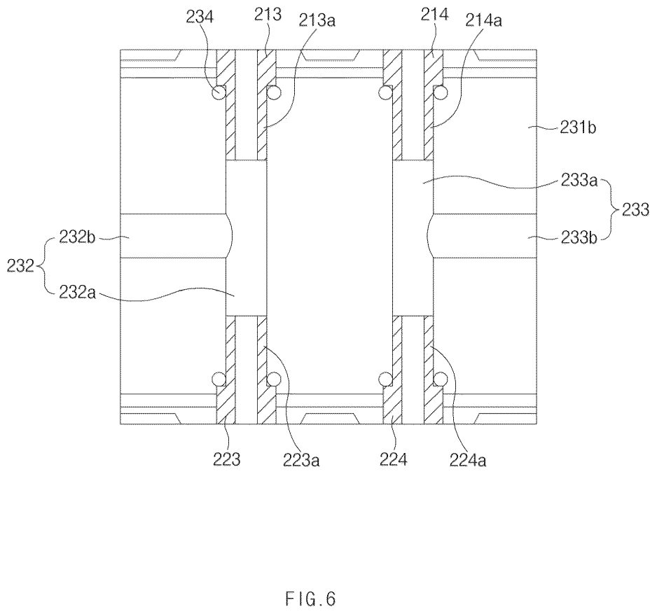

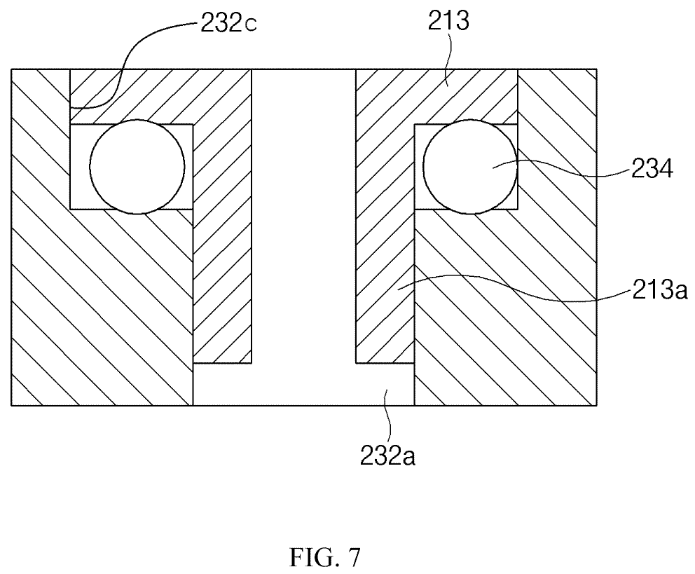

As illustrated in FIGS. 6 and 7, the connector member 230 includes a front plate 231, a supply part 232 and a collection part 233.

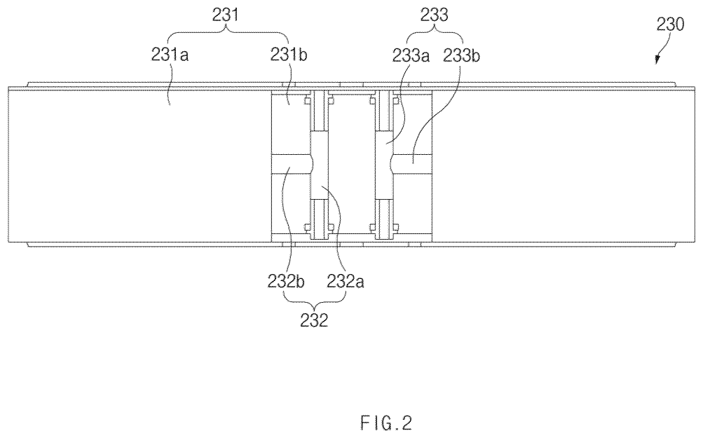

The front plate 231 is made of a metal material and covers one surface of the battery cell 100 in a full-length direction (a front surface of the battery cell when viewed in FIG. 2). That is, the front plate 231 is provided between a pair of side covers 231a, which cover both sides of one surface of the battery cell 100 in the full-length direction, respectively, and a central cover which is provided between the pair of side covers 231a and in which the supply part 232 and the collection part 233 are provided.

The front plate 231 may prevent the battery module 10 from increasing in volume because the supply part 232 and the collection part 233 are provided therein, and may protect the supply part 232 and the collection part 233 against an external impact.

The pair of side covers 231a and the central cover 231b may be integrally provided, as illustrated in FIG. 2, the central cover 231b may further protrude outward from the side covers 231a (front side of the battery cell when viewed in FIG. 2). Thus, a clearance (that is, an empty space) is provided between the central cover 231b and the battery cell 100, and the clearance allows the supply port and the battery cell 100 to be separated from each other and allows the discharge port and the battery cell 100 to be separated from each other, thereby preventing contact therebetween. In particular, the tolerance serves to block a temperature change of the battery cell, which is caused by the cooling water passing through the supply part and the collection part.

The supply part 232 is configured to supply the cooling water to the first and second supply ports. That is, the supply part 232 includes a first connection passage 232a and a supply passage 232b.

The first connection passage 232a is provided to pass vertically through the central cover 231b when viewed in FIG. 1, and the first supply port 213 and the second supply port 223 are coupled to the first supply port 213 and the second supply port 223 to supply the cooling water to the upper and lower ends of the first connection passage 232a, respectively. The supply passage 232b passes from the outside of the central cover 231b to the first connection passage 232a to supply the cooling water to the first connection passage 232a.

The inlet of the supply passage 232b may be provided to pass from a side portion (left portion of the central cover 231b when viewed in FIG. 6) of the central cover 231b, which protrude to the outside of the side cover 231a, to the first connection passage 232a. That is, since the central cover protrudes more outward than the side cover, the supply passage may be connected to the first connection passage through a side surface of the central cover. Thus, when viewed in FIG. 2, usability of a space between a front surface of the side cover 231a and a left surface of the central cover 231b may increase, and as a result, an increase in volume of the battery module 10 in the full-length direction may be prevented.

The collection part 233 is configured to collect the cooling water discharged from the first and second discharge ports. That is, the collection part 233 includes a second connection passage 233a and a collection passage 233b.

When viewed in FIG. 1, the second connection passage 233a is provided to pass vertically through the central cover 231b, and the first discharge port 214 and the second discharge port 224 are coupled to upper and lower ends of the second connection passage 233a, respectively, so that the cooling water passes through the first and second discharge ports. In addition, the collection passage 233b passes from the side portion of the central cover 231b (a right side of the central cover 231b when viewed in FIG. 6) to the second connection passage 233a to collect the cooling water passing through the second connection passage 233a.

The collection passage 233b passes from the side portion of the central cover 231b protruding to the outside of the side cover 231a to the second connection passage 233a. That is, since the central cover protrudes more outward than the side cover, the collection passage may be connected to the second connection passage through the side surface of the central cover. Thus, usability of a side space of the central cover 231b may be improved, and as a result, the increase in volume of the battery module 10 in the full-length direction may be minimized.

A coupling hole 232c into which each of the first supply port 213 and the second supply port 223 is fitted may be defined in each of both ends of the first connection passage 232a, and each of the first and second supply ports 213 and 223 and the coupling hole 232c may have a diameter greater than that of the first connection passage 232a. Thus, after each of the first and second supply ports 213 and 223 is inserted into the coupling hole 232c, the first and second supply ports 213 and 223 may be supported by the first connection passage 232a to improve the coupling therebetween.

In particular, a coupling piece 213a, 223a that is fitted into the first connection passage 232a is disposed on each of the first supply port 213 and the second supply port 223, respectively. That is, the coupling piece 213a, 223a has a cylindrical shape. Thus, coupling force and sealing force between the first connection passage 232a and the first and second supply ports 213 and 223 may increase.

A sealing ring 234 may be provided between the coupling hole 232c of the first connection passage 232a and the first supply port 213 or between the coupling hole 232c of the first connection passage 232a and the second supply port 223. That is, sealing force between the coupling hole 232c of the first connection passage 232a and the first supply port 213 or between the coupling hole 232c of the first connection passage 232a and the second supply port 223 may be significantly improved. Two or more sealing rings 234 may be provided.

A coupling hole 233c into which each of the first and second discharge ports is fitted is defined in each of both ends of the second connection passage 233a, and each of the first and second discharge ports and the coupling hole 233c has a diameter greater than that of the second connection passage 233a. Thus, after each of the first and second discharge ports is inserted into the coupling hole 233c, the first and second discharge ports may be supported by the second connection passage 233a to improve coupling therebetween.

A coupling piece 214a, 224a coupled to the second connection passage 233a is disposed on each of the first discharge port 214 and the second discharge port 224, respectively. That is, the coupling piece 214a, 224a has a cylindrical shape. Thus, coupling force and sealing force between the second connection passage 233a and the first and second discharge ports may increase.

A sealing ring 234 may be provided between the coupling hole of the second connection passage 233a and the first discharge port 214 or between the coupling hole of the second connection passage 233a and the second discharge port 224. That is, sealing force between the coupling hole of the second connection passage 233a and the first supply port 214 or between the coupling hole of the second connection passage 233a and the second supply port 224 may be significantly improved.

The case assembly 200 may further include a pair of side plates 240 respectively covering both sides in the full-width direction of the battery cell 100. In particular, the side plate 240 may be integrated with the bottom plate 221 to improve efficiency when assembling the battery module.

The case assembly 200 may further include a rear plate 250 covering the other side of the battery cell 100 in the full-width direction. Thus, the other side of the battery cell 100 in the full-width direction may be stably protected.

On the other hand, the case assembly 200 may accommodate and cool the entire battery cell 100 while the top plate 211, the bottom plate 221, the pair of side plates 240, and the rear plate 250 are assembled.

The battery module 10 according to the first embodiment of the present invention having the above configuration may uniformly cool the upper and lower portions of the battery cell 100, and in particular, minimize the temperature deviation of the entire battery cell 100, and as a result, the cooling efficiency may be improved.

Hereinafter, a method of assembling and operating the battery module 10 according to the first embodiment of the present invention will be described.

### Method for Assembly and Operating Battery Module According to First Embodiment of the Present Invention

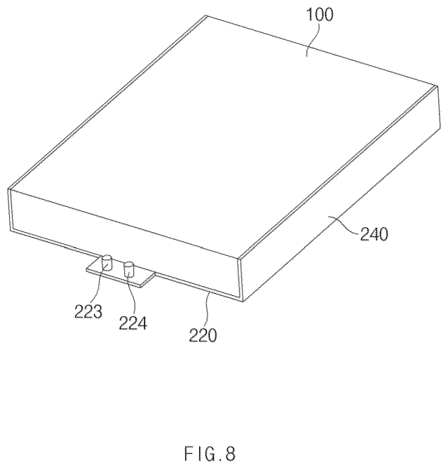

First, as illustrated in FIG. 8, a battery cell 100 is disposed on a top surface of a bottom plate 221 with which a side plate 240 is integrated. Here, a second supply port 223 and a second discharge port 224, which are coupled to a lower extension part 221a of the bottom plate 221, are spaced apart from the battery cell 100.

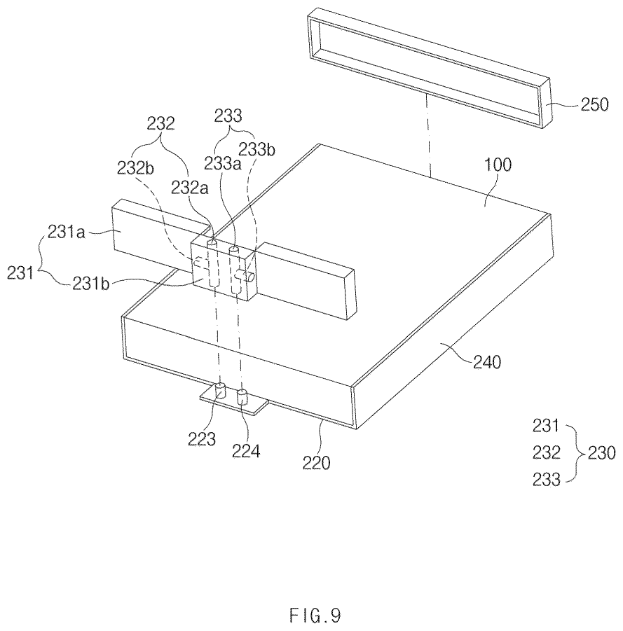

Next, as illustrated in FIG. 9, the connector member 230 is disposed on one surface of the battery cell 100 in a full-width direction, but a lower end of a first connection passage 232a and a second supply port 223, which is provided in the supply part 232, and a second supply port 223 are coupled to each other, and a lower end of the second connection passage 233a and a second discharge port 224, which are provided in a collection part 233, are coupled to each other. Here, the second supply port 223 may be coupled to a coupling hole provided in a lower end of the first connection passage 232a, and a coupling piece 223a of the second supply port 223 may be coupled to the first connection passage 232a to improve coupling force. In addition, the second discharge passage may be coupled to a lower end of the second connection passage 233a, and a coupling piece 224a of the second discharge port 224 may be coupled to the second connection passage 233a to improve coupling force. In addition, a sealing ring 234 is provided between the first connection passage 232a and the second supply port 223 and between the second connection passage 233a and the second discharge port 224 to improve sealing force.

Next, a rear plate 250 is coupled to the other surface of the battery cell 100 in a full-length direction.

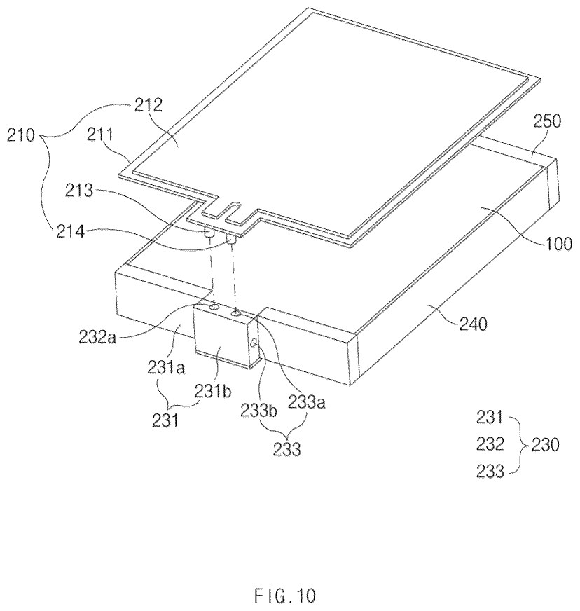

Next, as illustrated in FIG. 10, a top cooling member 210 is placed on an upper portion of the battery cell 100. Here, a first supply port 213 and a first discharge port 214, which are coupled to an upper extension part 211a of a top plate 211, are spaced apart from the battery cell 100. Then, the first supply port 213 and an upper end of the first connection passage 232a are coupled to each other, and the first discharge port 214 and an upper end of the second connection passage 233a are coupled to each other. Here, the first supply port 213 may be coupled to a coupling hole provided in an upper end of the first connection passage 232a, and a coupling piece 213a of the first supply port 213 may be coupled to the first connection passage 232a to improve coupling force. In addition, the first discharge passage may be coupled to an upper end of the second connection passage 233a, and a coupling piece 214a of the first discharge port 214 may be coupled to the second connection passage 233a to improve coupling force. In addition, a sealing ring 234 is provided between the first connection passage 232a and the first supply port 213 and between the second connection passage 233a and the first discharge port 214 to improve sealing force.

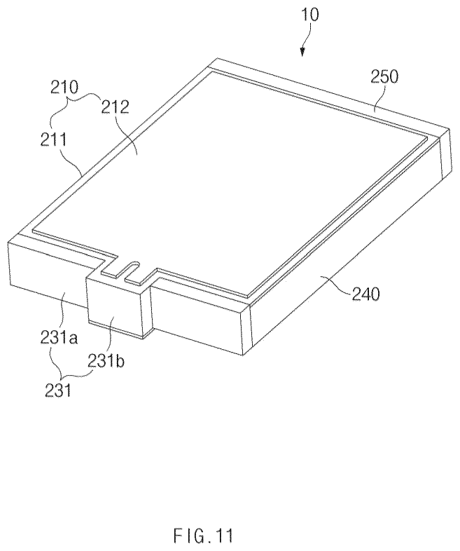

When the assembly is completed as described above, a finished battery module 10 as illustrated in FIG. 11 may be obtained.

In the finished battery module 10 as described above, a cooling water supply line is connected to a supply passage 232b of a supply part 232, and a cooling water collection line is connected to a collection passage 233b of a collection part 233. In addition, while charging and discharging the battery module 10, the cooling water is supplied to the battery module 10 through a supply line. Then, the cooling water supplied through the supply line sequentially passes through the supply passage 232b, the first connection passage 232a, and the first and second supply ports 213 of the supply part 232 and 223, and then is introduced into first and second heatsinks 212 and 222 to cool the entire battery cell 100. The cooling water passing through the first and second heatsinks 212 and 222 is introduced into the second connection passage 233a through the first and second discharge ports 214 and 224, and the cooling water introduced into the second connection passage 233a is collected into the collection line through the collection passage 233b. Next, the cooling water is supplied to the supply line again after performing a cooling process.

Hereinafter, in describing another embodiment of the present invention, the same reference numerals are used for the same components as those of the above-described embodiment, and duplicated descriptions will be omitted.

### Battery Pack According to Second Embodiment of the Present Invention

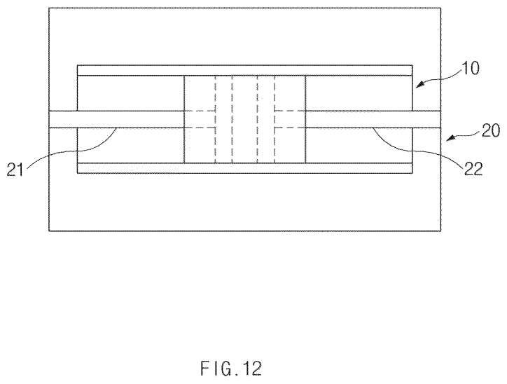

As illustrated in FIG. 12, a battery pack according to a second embodiment of the present invention includes a battery module 10; and a pack case 20 in which at least one or more battery modules 10 are accommodated.

The battery module 10 has the same configuration as the battery module 10 described in the first embodiment, and therefore, redundant description will be omitted.

The pack case 20 includes a supply line 21 that supplies cooling water to a supply passage 232b of the battery module 10 and a collection line through which the cooling water collected from the collection passage 233b of the battery module 10 passes. That is, the supply line is connected to the supply passage 232b of a supply part 232 provided in the battery module 10, and the collection line is connected to the collection passage 233b of a collection part 233 provided in the battery module 10.

Therefore, the battery pack 1 according to the second embodiment of the present invention may improve cooling efficiency of the battery module 10 as a whole, and in particular, may minimize a cooling deviation.

### Vehicle According to Third Embodiment of the Present Invention

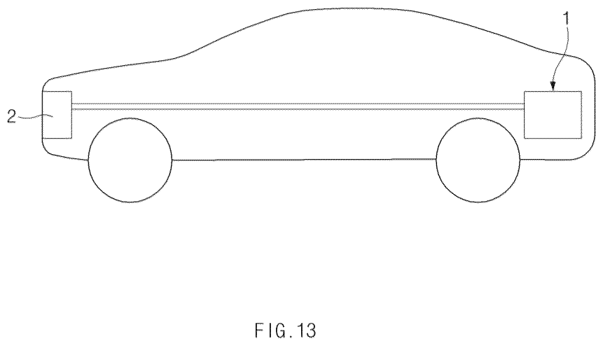

As illustrated in FIG. 13, a vehicle according to a third embodiment of the present invention includes a battery pack 1; and a cooling water supply device 2 configured to supply cooling water to a supply line of the battery pack 1 or collect the cooling water passing through a collection line.

The battery pack has the same configuration as the battery pack described in the second embodiment, and therefore, redundant description is omitted.

The cooling water supply device may be a radiator that cools an engine using the cooling water. That is, the radiator supplies a portion of the cooling water that cools the engine to the battery pack or collects the cooling water passing through the battery pack.

Therefore, the vehicle according to the third embodiment of the present invention may improve its performance by including the battery pack with high cooling efficiency.

The case assembly may function as the battery module or the battery pack, and in particular, the case assembly may separately include a housing, which accommodates the battery cells, at the outside thereof.

Accordingly, the scope of the present invention is defined by the appended claims more than the foregoing description and the exemplary embodiments described therein. Various modifications made within the meaning of an equivalent of the claims of the invention and within the claims are to be regarded to be in the scope of the present invention.

### DESCRIPTION OF THE SYMBOLS

1: Battery pack
2: Cooling water supply device
10: Battery module
20: Pack case
21: Supply line
22: Collection line
100: Battery cell
200: Case assembly
210: Top cooling member
211: Top plate
211a: Upper extension part
212: First heatsink
213: First supply port
213a, 214a, 223a, 224a: Coupling piece
214: First discharge port
220: Bottom cooling member
221: Bottom plate
221a: Lower extension part
222: Second heatsink
223: Second supply port
224: Second discharge port
230: Connector member
231: Front plate
231a: Side cover
231b: Central cover
232: Supply part
232a: First connection passage
232b: Supply passage
232c: Coupling hole
233: Collection part
233a: Second connection passage
233c: Coupling hole
233b: Collection passage
234: Sealing ring
240: Side plate
250: Rear plate

1. A battery module comprising:
a case assembly configured to accommodate and cool a battery cell,
wherein the case assembly comprises:
a top cooling member provided with a top plate configured to cover a top surface of the battery cell, a first heatsink configured to cool the top surface of the battery cell while cooling water passes therethrough, a first supply port configured to supply the cooling water to the first heatsink, and a first discharge port configured to discharge the cooling water passing through the first heatsink;
a bottom cooling member provided with a bottom plate configured to cover a bottom surface of the battery cell, a second heatsink configured to cool the bottom surface of the battery cell while the cooling water passes therethrough, a second supply port configured to supply the cooling water to the second heatsink, and a second discharge port configured to discharge the cooling water passing through the second heatsink; and
a connector member provided with a front plate configured to cover a front surface of the battery cell, a supply part configured to supply the cooling water to the first supply port and the second supply port, and a collection part configured to collect the cooling water discharged from the first discharge port and the second discharge port,
wherein the front plate comprises:
a pair of side covers configured to cover sides of the first surface, respectively; and
a central cover which is provided between the pair of side covers,
wherein the central cover protrudes outward from each of the pair of side covers.

2. The battery module of claim 1, wherein the supply part and the collection part are provided in the front plate.

3. The battery module of claim 2, wherein the supply part comprises:
a first connection passage provided in the central cover to pass vertically and having an upper end and a lower end, to which the first supply port and the second supply port are coupled respectively, to supply the cooling water to the first and second supply ports; and
a supply passage configured to pass from an outside of the central cover to the first connection passage and supply the cooling water to the first connection passage.

4. The battery module of claim 3, wherein the supply passage is configured to pass from a first side portion of the central cover, which protrudes from a first side cover of the pair of side covers, to the first connection passage.

5. The battery module of claim 2, wherein the collection part comprises:
A second connection passage provided in the central cover to vertically pass and having an upper end and a lower end, to which the first discharge port and the second discharge port are coupled, respectively, so that the cooling water discharged from the first and second discharge ports passes therethrough; and
a collection passage configured to pass from outside of the central cover to the second connection passage and collect the cooling water passing through the second connection passage.

6. The battery module of claim 5, wherein the collection passage is configured to pass from a second side portion of the central cover, which protrudes from a second side cover of the pair of side covers, to the second connection passage.

7. The battery module of claim 3, wherein a coupling hole into which each of the first and second supply ports is fitted is defined in each of the ends of the first connection passage, and
wherein a coupling piece on each of the first supply port and the second supply port is coupled to the first connection passage.

8. The battery module of claim 5, wherein a coupling hole into which each of the first and second discharge ports is fitted is defined in each of the ends of the second connection passage, and
wherein a coupling piece on each of the first discharge port and the second discharge port is coupled to the second connection passage.

9. The battery module of claim 7, wherein a sealing ring is provided between the coupling hole of the first connection passage and the first supply port or between the coupling hole of the first connection passage and the second supply port.

10. The battery module of claim 8, wherein a sealing ring is provided between the coupling hole of the second connection passage and the first discharge port or between the coupling hole of the second connection passage and the second discharge port.

11. The battery module of claim 1, further comprising a pair of side plates configured to cover side surfaces of the battery cell, respectively.

12. The battery module of claim 11, wherein the pair of side plate and the bottom plate are integrated with each other.

13. The battery module of claim 1, further comprising a rear plate configured to cover a rear surface of the battery cell.

14. A battery pack comprising:
a pack case in which at least one battery module of claim 1 are accommodated,
wherein the pack case comprises:
a supply line configured to supply cooling water to the supply passage of the at least one battery module; and
a collection line through which the cooling water collected from the collection passage of the at least one battery module passes.

15. A vehicle comprising:
a battery pack of claim 14; and
a cooling water supply device configured to supply cooling water to the supply line of the battery pack or collect the cooling water passing through the collection line.
